(19) United States
(12) Patent Application Publication
(10) Pub. No.: US 2024/0224842 A9
(43) Pub. Date: Jul. 11, 2024

(54) MODULATING AGRICULTURAL SPRAYER CONTROL AND METHODS FOR SAME

(71) Applicant: Raven Industries, Inc., Sioux Falls, SD (US)

(72) Inventors: Jared Ernest Kocer, Sioux Falls, SD (US); Nicholas O. Michael, Sioux Falls, SD (US)

(21) Appl. No.: 18/490,540

(22) Filed: Oct. 19, 2023

Related U.S. Application Data
(60) Provisional application No. 63/380,308, filed on Oct. 20, 2022.

(51) Int. Cl. A01C 21/00; A01C 23/04; A01M 7/00; A01M 21/04

(52) U.S. Cl. CPC A01C 21/007; A01C 23/047; A01M 7/0089; A01M 21/043

(57) ABSTRACT

A spraying system for an agricultural sprayer includes a plurality of nozzle assemblies configured for positioning along a sprayer boom. Each of the plurality of nozzle assemblies is in communication at least one boom tubes. A nozzle controller is in communication with the plurality of nozzle assemblies, and the nozzle controller is configured to control one or more of the nozzle assemblies of the plurality to provide a targeted application of agricultural product.

### CLAIMS OF PRIORITY

This patent application claims the benefit of priority U.S. Provisional Patent Application Ser. No. 63/380,308, titled “MODULATING AGRICULTURAL SPRAYER CONTROL AND METHODS FOR SAME,” filed on Oct. 20, 2022, which is hereby incorporated by reference herein in its entirety.

### TECHNICAL FIELD

The present disclosure pertains generally, but not by way of limitation, to agricultural sprayers and the application of sprayed agricultural products.

### BACKGROUND

Agricultural sprayers apply an agricultural product to crops for husbandry of the crop or field. For instance, sprayers apply fertilizers, herbicides, pesticides or the like. Agricultural sprayers include product reservoirs, sprayer booms and spray nozzles along the sprayer booms in communication with the product reservoirs.

In some examples, agricultural sprayers apply a single agricultural product from the product reservoir through the spray nozzles. The agricultural product is applied as a broad application, for instance with an ongoing flow rate, that provides sprayed application of the product through the spray nozzles. In another example, the agricultural sprayer includes first and second agricultural products in discrete reservoirs, and first and second arrays of nozzles that are in communication with the respective reservoirs. Each of the first and second arrays of nozzles provide a broad ongoing application of the respective agricultural products.

Other agricultural sprayers include first and second agricultural products in discrete reservoirs. A first array of nozzles is connected with the first reservoir, and the first array of nozzles are configured to provide a base application of the first agricultural product. A second array of nozzles is connected with the second reservoir, and the second array of nozzles provides a refined application of the second agricultural product. For instance, the second agricultural product is a higher cost product, and accordingly directed application decreases overall use of the second agricultural product.

### SUMMARY

The present inventors have recognized, among other things, that a problem to be solved can include minimizing the application of large quantities of agricultural products, for instance with broad application of products from sprayer nozzles and at the same time providing targets application of products. For instance, in some examples, an agricultural sprayer can include a product reservoir interconnected with spray nozzles with intervening plumbing. The agricultural product is applied as a broad application, for instance with an ongoing flow rate, that is applied throughout a field. In another example, the agricultural sprayer includes first and second agricultural products in discrete reservoirs, and first and second arrays of nozzles that are in communication with the respective reservoirs. For instance, the dedicated and separate sets of plumbing interconnect the first and second arrays of nozzles with the respective reservoirs. Each of the first and second arrays of nozzles provide a broad ongoing application of the respective agricultural products. The broad application of agricultural products is expensive, and in some examples, applies the products where less effective (e.g., to soil instead of crop or the like).

In other examples, a system includes a first array of nozzles, plumbing and associated product reservoir that broadly applies a first application of an agricultural product. The system includes a distinct second array nozzles, respective plumbing and product reservoir for a second agricultural product. In an example, the second array of nozzles are operated in a more limited manner relative to the first array. For instance, the operator selectively activates and deactivates the second array of nozzles. In another example, a prescription map is provided that includes locations for selective application of the second agricultural product through the second array of nozzles. As the second array of nozzles arrives at the prescribed locations the nozzles are activated to apply the second agricultural product. Optionally, the agricultural sprayer includes a camera configured to identify plants, and a controller activates the second array of nozzles when near the identified plants.

A problem with each of these systems is the dedicated plumbing for each of the first and second agricultural products including distinct arrays of first and second nozzles, first and second boom tubes and first and second agricultural product reservoirs. An additional problem is the broad application of one or more agricultural products that is expensive, and in some examples unnecessary where the product is applied to a non-specified target.

The present subject matter can help provide a solution to these problems with a system that consolidates plumbing while at the same time facilitating directed application of agricultural products to minimize consumption of the products. The present subject matter includes examples of supplementing sprayer systems and composite sprayer systems that include one or more of composite boom tubes connected with arrays of nozzles, and controllers that in some examples selectively apply agricultural products. The selective application of agricultural products provides targeted lower cost application of expensive agricultural products. In some examples a composite boom tube including two or more separated passages is provided with the system to decrease duplication of plumbing tubing and accordingly further decrease the cost of the system while at the same time facilitating the delivery of one or more multiple agricultural products.

In one example, a supplementing spraying system includes a base nozzle array having a plurality of base nozzles controlled with a base nozzle controller (including multiple base nozzle controllers). A plurality of supplemental nozzle assemblies are configured to spray a supplemental agricultural product that is the same or different from a base agricultural product sprayed with the base nozzle array. Each of the supplemental nozzle assemblies includes a supplemental spray nozzle and a modulating element to control one or more application characteristics, such as flow rate, droplet size or the like from the supplemental spray nozzle. A supplemental nozzle controller (including multiple supplemental nozzle controllers) is in communication with the plurality of supplemental nozzle assemblies. The supplemental nozzle controller is configured to control the modulating elements of the supplemental nozzle assemblies.

In an example, the supplemental nozzles are positioned between the base nozzles of the base nozzle array to provide overlapping coverage of the base spray from the base nozzles. Overlapping includes, but is not limited to, partial or full overlapping, coincident spraying, cooperative spraying, partial or full aligned spraying, juxtaposed or adjacent spraying or the like.

In one example, the supplemental nozzle assemblies provide a supplemental application of the supplemental agricultural product. As provided herein the supplemental agricultural product is the same as the base agricultural product (e.g., from a common boom tube) or is a different product. The supplemental nozzle controller operates the supplemental nozzle assemblies, collectively or independently, for instance based on identified targets sensed with target sensors, a prescription or the like (herein referred to as examples of target applications). The supplemental application in an example is more limited than the application by the base nozzle array and accordingly decreases use of agricultural product. In another example, supplemental application is a targeted application based on identified and indexed targets (e.g., crops, pests, weeds or the like), for instance observed with one or more target sensors. The supplemental nozzle controller operates supplemental nozzle assemblies having a nozzle location comparable to a target location (e.g., coincident, proximate to, within 6 inches, 12 inches or the like) and initiates and arrests spraying at the target location (including proximate to the target location).

In another example, a composite spraying system, includes composite nozzle assemblies distributed along a sprayer boom. The composite nozzle assemblies are in communication with one or more types of an agricultural product. The composite nozzle assemblies include multiple nozzles and modulating elements (e.g., control valves, orifice plates, modulating nozzles or the like) configured to spray the one or more agricultural product. Optionally, the composite nozzle assemblies include a modulating nozzle and mixing chamber that mixes agricultural products together. The modulating nozzle includes one or more modulating elements that control flow rate (e.g., adjusted based on the composition or flow rates of agricultural products), droplet size, spray pattern or the like (herein spray characteristics). The modulating nozzle differs from control valves in that the modulating elements include one or more of orifice plates, gates, plungers or the like that are proximate to a spray port to accordingly control flow rate and optionally the spray profile (e.g., droplet size, pattern or the like).

The composite nozzle assemblies provide targeted applications of agricultural products to identified and indexed targets. In one example, the targets are provided by previous scanning of a field, for instance with a drone, during a previous agricultural operation or the like. The targets are indexed to a field map, and the composite spraying system conducts targeted applications as one or more composite nozzle assemblies arrive at the targets. For instance, a target location comparator determines the difference in location between the composite nozzle and the target. Upon reaching a threshold difference (e.g., arrival at the target, 2 inches before the target, 6 inches before the target or the like) the composite nozzle assembly is activated to apply the targeted application of one or more agricultural products.

Optionally, a target module includes an agricultural product selector configured to further refine the application of one or more agricultural products. For instance, an identified target may have various characteristics, crop type (crop, variety or the like), weed type, pest type, quantity or density of the target, agricultural product(s), associated flow rate or quantity values, droplet size, spray pattern, boom height or spray height or the like. These characteristics are variously referred to as target characteristics, application characteristics, prescriptions or the like associated with the identified target. The agricultural product selector provides the application characteristics to nozzle controllers associated with the composite nozzle assemblies to provide the specified application prescription to the target.

In another example, the composite spraying system includes one or more target sensors that are directed to a zone preceding the composite nozzle assemblies. For instance, target sensors include, but are not limited to, red-blue-green (RBG) cameras, video, normalized vegetation index (NVDI) or the like directed to the zone in front of a sprayer boom. The target sensors are in communication with one or more of the target module and associated controllers, such as first and second nozzle controllers for composite nozzle assemblies (including a composite controller). In one example, the target module receives observations from the target sensors and identifies and indexes targets for instance with a target identification module and a target indexing module. Optionally, the target identification module identifies the potential target and also further identifies characteristics of the target or associates characteristics with the target to provide an application prescription or application characteristics for implementation by the composite nozzle assemblies.

The composite spraying system provides targeted application of one or more agricultural products while decreasing (including eliminating) broad applications of products. The system permits the identification of various targets including characteristics of the targets to select agricultural products for application that are suited for the identified target including fertilizer for crops, differing types of fertilizer based on crop observations, herbicides or types of herbicides for different weeds or the like. Additionally, characteristics of the target or characteristics associated with the target are optionally included with identification to further refine application (e.g., flow rate, droplet size, spray pattern, application height or the like). The targeted application of agricultural products decreases the overall use of products and at the same time provides effective applications that readily address issues with the identified targets.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

Various ones of the appended drawings merely illustrate example embodiments of the present disclosure and should not be considered as limiting its scope.

FIG. 1 is a perspective view of one example of an agricultural sprayer.

FIG. 2 is a schematic view of one example of a supplementing spraying system.

FIG. 3 is a schematic view of one example of composite spraying system.

FIG. 4 is a schematic view of one example of a target module.

FIG. 5A is a schematic view of portions of an example configuration of the composite spraying system with fertilizer and herbicide.

FIG. 5B is a schematic view of portions of another example configuration of the composite spraying system with different herbicides.

FIG. 5C is a schematic view of portions of an additional example configuration of the composite spraying system with different fertilizers.

FIG. 6 is a schematic view of one example of a composite nozzle assembly.

FIG. 7 is a schematic view of a modulating nozzle assembly in communication first and second boom tubes.

FIG. 8 is a schematic view of the modulating nozzle assembly in communication first and second boom tubes of a composite boom tube.

FIG. 9 is a perspective view of one example of a modulating nozzle assembly.

### DETAILED DESCRIPTION

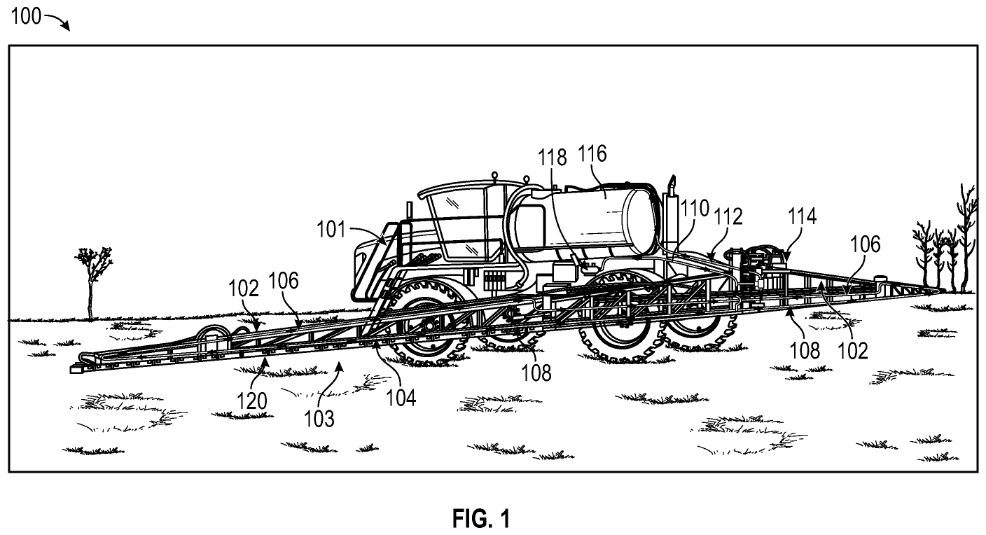

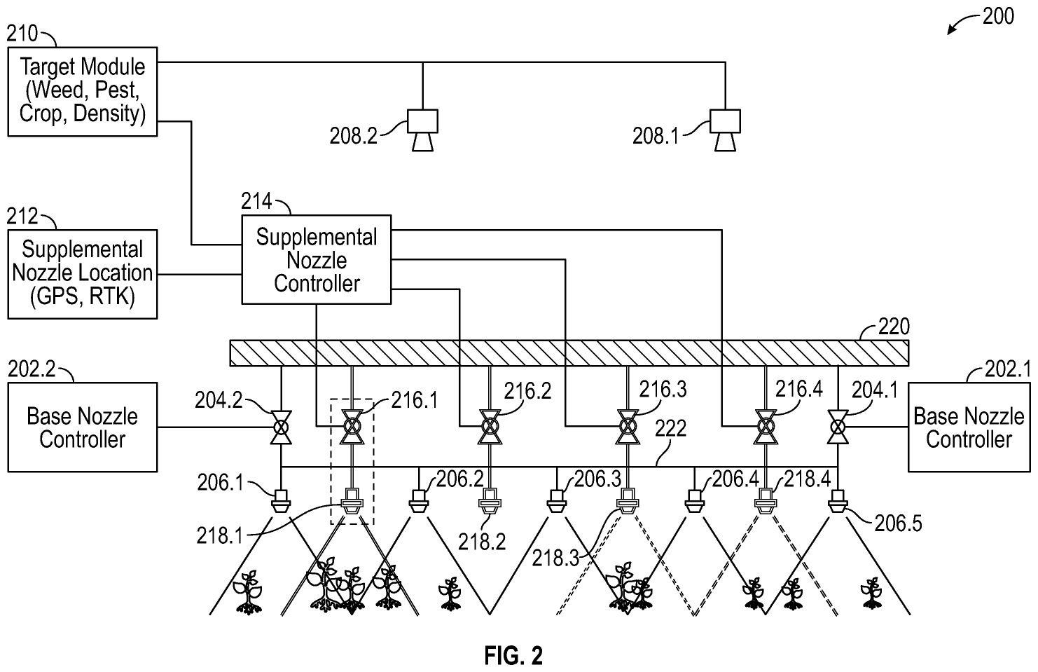

FIG. 1 is a perspective view of one example of agricultural sprayer 100. The sprayer 100 includes a chassis 101 that carries a supply tank 116 of an agricultural solution including a carrier fluid and mixed agricultural product including, but not limited to, fertilizers, herbicides, pesticides or the like. Optionally, the supply tank 116 stores the carrier fluid, such as water, and a separate agricultural product reservoir (see FIG. 2) provides the agricultural product for metered administration to the carrier fluid prior to delivery to the sprayer booms 102.

The agricultural sprayer 100 includes a spraying system extending from the supply tank 116 to one or more product dispensers 120 along sprayer booms 102. The sprayer booms 102 extend from the chassis 101 and each include respective sprayer boom tubes 104. As shown in the schematic illustration overlaying the sprayer 100 the supply tank 116 includes a main line 110 and a system pump 118 along the main line 110. The main line 110 is in communication with the sprayer boom tubes 104. Operation of the system pump 118 delivers the mixed agricultural solution to the sprayer boom tubes for delivery through one or more product dispensers 120. The product dispensers 120 include, but are not limited to, one or more nozzles, arrays of nozzles, boom sections or the like. As further shown in FIG. 1, the sprayer boom tubes 104 include proximal and distal portions 106, 108. For example, the proximal portions 106 extend along the sprayer booms 102 toward the respective ends of the booms 102 remote from the chassis 101. The distal portions 108 of the sprayer boom tubes 104 extend from the ends of the booms 102 toward the chassis 101. In this example, the product dispensers 120 are provided along the distal portions 108.

In spraying operation a control valve 114 (e.g., a three way control valve or the like) is interposed between the main line 110, the sprayer boom tubes 104 and a return line is configured to deliver the pumped agricultural solution from the supply tank 116 to at least one of the sprayer boom tubes 104 (e.g., the proximal portion 106 of the right boom tube 104). In the view shown in FIG. 1, the main line 110 is also in communication with the opposed (left) sprayer boom tube 104. The agricultural solution is delivered from the supply tank 116 by the system pump 118 and to each of the sprayer boom tubes 104 by way of the main line 110 and, in this example, the control valve 114. The proximal portions 106 of the sprayer boom tubes 104 deliver the agricultural solution to the ends of the sprayer booms 102, and the agricultural solution returns along the distal portions 108 of the sprayer boom tubes 104 for dispensing in the one or more product dispensers 120.

In some examples, recirculation of the fluids through the sprayer system 103 is specified. For instance, during idling of the agricultural sprayer 100 the agricultural products in the carrier fluid of the agricultural solution settle, agglomerate or the like. Recirculation of the agricultural solution mixes the agricultural solution and accordingly redistributes the products into the carrier fluid. In other examples, cleaning of the sprayer system 103 is specified, for instance to remove residue of a first agricultural product for a second agricultural product. Where recirculation is specified the sprayer system 103 is reconfigured relative to the spraying operation.

In recirculation operation the control valve 114 is operated to interconnect the return line 112 (extending to the supply tank 116) with the remainder of the sprayer system 103. For example, a three way valve is oriented to open communication to the return line 112 while isolating the corresponding portion of the sprayer boom tube 104, in this example the right tube, from agricultural solution from the main line 116. While recirculating the system pump 118 continues to pump the agricultural solution from the supply tank 116 to one of the sprayer boom tubes 104 (e.g., the left tube in this example). The solution is delivered in a linear manner along the proximal portion 106 to the end of the sprayer boom 102, and from the end along the distal portion 108 toward the chassis 101. Optionally, the product dispensers 120 are closed if mixing of the solution is specified (e.g., to remix settled agricultural products). In another example, the product dispensers 120 are opened (including partially opened) to clean the sprayer system 103 by flushing residual agricultural product from the dispensers.

The agricultural solution continues from the distal portion 108 of the first sprayer boom tube 104 (the sprayer boom tube associated with the left sprayer boom 102 in this example) to the distal portion 108 of the second sprayer boom tube 104 (e.g., the tube associated with the right sprayer boom 102). The recirculating agricultural solution travels along the distal portion 108 of the sprayer boom tube 104 and passes through the proximal portion 106 of the boom tube 104 toward the chassis 101. The reoriented control valve 114, for instance a three way valve 114, communicates the recirculated agricultural solution to the return line 112 for delivery to the supply tank 116 to complete the circuit from the supply tank 116 to and through the sprayer boom tubes 104 and back to the supply tank 116. When spraying operation is specified the control valve 114 is operated to close communication with the return line 112 and thereby reinitiate communication of the agricultural solution from the supply tank 116 to the proximal portions 106 of the sprayer boom tubes 104 and distribution through the product dispensers 120 along the distal portions 108 of the tubes 104.

The recirculation operation described in FIG. 1 is used with agricultural solutions having a specified, constant, mix or concentration of products because the solution is recirculated to the supply tank 116 having the agricultural solution. Recirculation in this manner, if used with a supply tank 116 housing a carrier fluid (e.g., water) and separate agricultural product reservoirs would ‘spoil’ the carrier fluid by introducing the mixed agricultural solution into the carrier fluid within the supply tank 116.

In other agricultural sprayers 100 the spraying system includes agricultural product reservoirs having one or more agricultural products that are injected to the carrier fluid to modulate concentrations and compositions of the agricultural solution for high resolution spraying operations. The supply tank 116 having the carrier fluid alone frustrates ongoing control of concentration or composition with recirculation because recirculation of the agricultural solution including the injected products in the carrier solution to the supply tank 116 spoils (e.g., intermixes) the carrier fluid for ongoing (future) administration of agricultural products.

FIG. 2 is a schematic view of one example of a supplementing spraying system 200. The supplementing spraying system 200 includes a one or more base nozzle controllers 202.1, 202.2. The base nozzle controllers 202.1, 202.2 are in communication with one or more base modulating elements 204.1, 204.2 and a plurality of base nozzles 206.1-206.5. A boom tube 220 includes an agricultural product or composite boom tube with separated carrier fluid and additive fluid (e.g., separate tubes, septum isolated or the like). The boom tube 220 is coupled to a base array component tube 222. In some examples, the base nozzle array, including the one or more base modulating elements 204.1, 204.2 and plurality of base nozzles 206.1-206.5, receives the agricultural product from the base array component tube 222 interconnected with the boom tube 220. In some other examples, the base nozzle array, including the one or more base modulating elements 204.1, 204.2 and plurality of base nozzles 206.1-206.5, is directly coupled to the boom tube 220.

The base nozzle controllers 202.1, 202.2 are configured to control application of a base flow rate of an agricultural product from the plurality of base nozzles 206.1-206.5. In some examples, the base nozzle controllers 202.1, 202.2 control the agricultural product flow rate according to a field map prescription and variations in the same (e.g., based on zones having varied prescriptions).

The targets for the supplementing spraying system 200 can include different types of targets, such as one more of rows, zones, weeds, crops, plants, pests, and the like. Supplemental spraying system 200 is configured to detect the targets and control supplemental spraying of the agricultural product based on the detected targets. The supplemental spraying system 200 includes target sensors 208.1, 208.2. The target sensors 208.1, 208.2 include one or more of a RGB (Red Green Blue) sensor, video sensor, normalized difference vegetation index (NDVI), or the like. The target sensors 208.1, 208.2 are configured to monitor an area preceding one or more of supplemental nozzle assemblies to detect targets.

The target sensors 208.1, 208.2 are communicatively coupled to a target module 210. The target module 210 is also coupled to a supplemental nozzle location module 212 and a supplemental nozzle controller 214. In some examples, one or more of the target module 210, supplemental nozzle location module 212, and supplemental nozzle controller 214 are integrated together in one or more components, such as one or more processors.

The supplemental nozzle location module 212 provides the supplemental nozzle assembly location (e.g., with GPS, RTK, or the like). The target module 210 is configured to identify and index targets based on the information received from the target sensors 208.1, 208.2. The target module 212 is also configured to compare the target location (e.g., indexed location of the target) and supplemental nozzle location (GPS, RTK) received from the supplemental nozzle location module 212, which is used to activate or deactivate the one or more supplemental nozzle assemblies by the supplemental nozzle controller 214.

The identified target (e.g., target type, density, or the like) is received by the supplemental nozzle controller 214 to control application of the supplemental agricultural product (e.g., with greater target density the product is applied with a greater flow rate). As the supplemental nozzle assembly approaches a detected target (e.g., indexed locations near each other or coincides), the supplemental nozzle controller 214 activates the supplemental nozzle assembly. The supplemental nozzle controller 214 is configured to control the operations of supplemental nozzle assembly, which can include supplemental modulating elements 216.1-216.4 and supplemental nozzles 218.1-218.4, to supply supplemental agricultural product. The application of the supplemental agricultural product can be based on, for example, a prescription, identified targets detected by the target sensors 208.1, 208.2 or the like. In some examples, the supplemental nozzle controller 214 operates each of the supplemental base nozzles 218.1-218.4 collectively or independently. In some examples, the supplemental nozzle controller 214 can be provided as a plurality of supplemental nozzle controllers, each associated with a respective supplemental nozzle assembly.

As mentioned above, the supplemental nozzle assembly supplemental modulating elements 216.1-216.4 and supplemental base nozzles 218.1-218.4. the supplemental modulating elements 216.1-216.4 can include a modulating nozzle, control valve, or the like. In some examples, the supplemental nozzle assembly can provide a supplemental spray pattern that at least partially overlaps the base pattern from the base nozzle array (e.g., partial overlap, matches, coextensive, cooperatively sprays or the like). In some examples, supplemental spray pattern can be based on the identified targets.

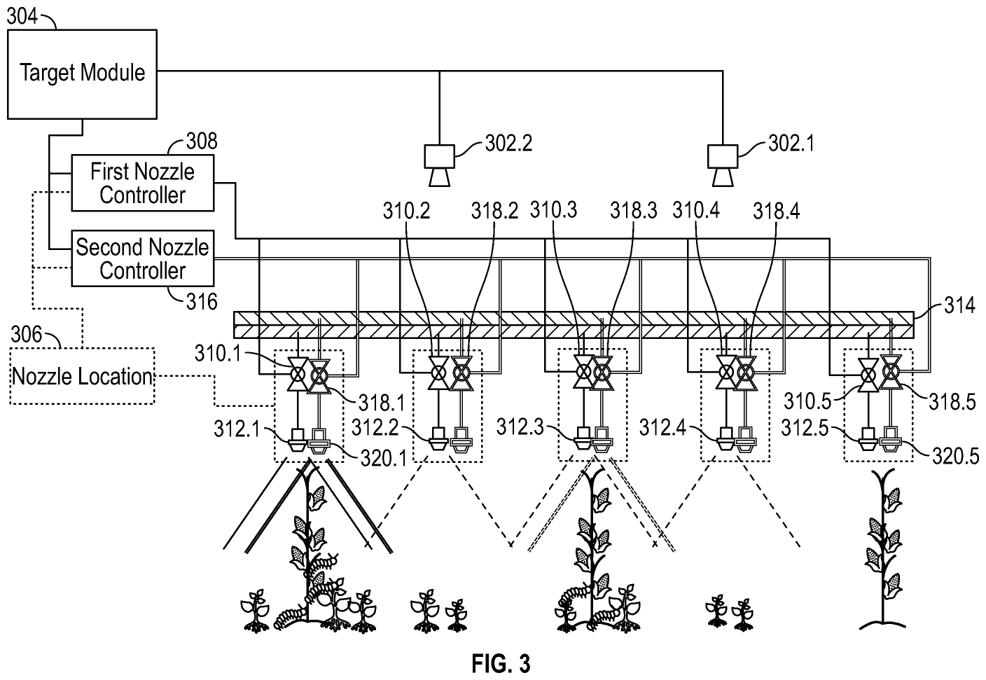

FIG. 3 is a schematic view of one example of composite spraying system 300. The composite spraying system can be used to apply two different agricultural products, such as herbicide and pesticide. The respective agricultural products can be applied based on different target identification. For example, herbicide can be applied to dispatch identified weeds and pesticide can be applied to dispatch identified pests.

The composite spraying system 300 includes target sensors 302.1, 302.2. The target sensors 302.1, 302.2 include one or more of a RGB sensor, video sensor, (NDVI), or the like. The target sensors 302.1, 302.2 are configured to monitor an area preceding one or more of supplemental nozzle assemblies to detect targets. The target sensors 302.1, 302.2 are configured to monitor an area preceding one or more of nozzle assemblies to detect targets.

The target sensors 302.1, 302.2 are communicatively coupled to a target module 304. The target module 304 is also coupled to a nozzle location module 306, a first nozzle controller 308, and a second nozzle controller 316. In some examples, one or more of target module 304, nozzle location module 306, and first nozzle controller 308, and second nozzle controller 316 are integrated together in one or more components, such as one or more processors.

The nozzle location module 306 provides respective nozzle assembly locations (e.g., with GPS, RTK, or the like). The target module 304 is configured to identify and index targets based on the information received from the target sensors 302.1, 302.2. The target module 304 is also configured to compare the target location (e.g., indexed location of the target) and respective nozzle location (GPS, RTK) received from the nozzle location module 306, which is used to activate or deactivate the one or more nozzle assemblies by the first nozzle controller 308 and second nozzle controller 316.

The first nozzle controller 308 is configured to control the operations of the first nozzle assembly, including first modulating elements 310.1-310.5 and first nozzles 312.1-312.5, to supply a first agricultural product, such as herbicide. The application of the first agricultural product can be based on, for example, a prescription, identified targets (e.g., weeds) detected by the target sensors 302.1, 302.2 or the like. In some examples, the first nozzle controller 308 operates each of the first nozzles assemblies collectively or independently. In some examples, the first nozzle controller 308 can be provided as a plurality of first nozzle controllers, each associated with a respective first nozzle assembly.

The second nozzle controller 316 is configured to control the operations of the second nozzle assembly, including second modulating elements 318.1-318.5 and second nozzles 320.1-320.5, to supply a second agricultural product, such as pesticide. The application of the second agricultural product can be based on, for example, a prescription, identified targets (e.g., pests) detected by the target sensors 302.1, 302.2 or the like. In some examples, the second nozzle controller 316 operates each of the first nozzles assemblies collectively or independently. In some examples, the second nozzle controller 316 can be provided as a plurality of second nozzle controllers, each associated with a respective second nozzle assembly.

In some examples, the first nozzle controller 308 and second nozzle controller 316 may be consolidated as a composite controller. The composite controller can be provided for a modulating nozzle assembly to control mixing of agricultural products (e.g., herbicide and pesticide) through the modulating assembly.

A composite boom tube 314 can include isolated passages configured to carry the first and second agricultural products, respectively. In some examples, separate boom tubes can be provided containing the first and second agricultural products, respectively. The composite spraying system 300 can also provide variations in flow rates of the first and second agricultural products based on identified targets proximate to the first and second nozzles.

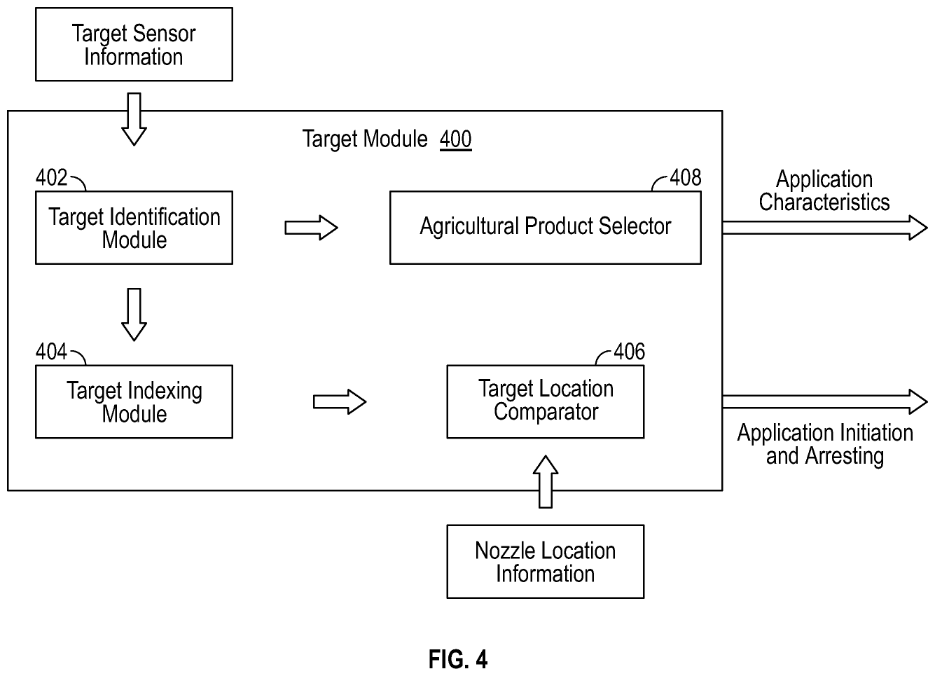

FIG. 4 is a schematic view of one example of a target module 400. In some examples, the target module 400 can be provided using one or more processors. The target module 400 includes a target identification module 402, a target indexing module 404, a target location comparator 406, and an agricultural product selector 408. The target identification module 402 receives target sensor information to identify targets for spray applications (e.g., crops, pests, weeds, soil, or the like). In some examples, the target identification module 402 is configured to further identify (e.g., discriminate) between types of targets, for instance to identify various pests, weeds, crops, soil types, or the like. The target identification module 402 can include one more of an onboard or remote target library, identification algorithm, learning algorithm, artificial intelligence based on deep learning algorithm, or the like configured to identify targets. For example, the target identification module 402 can compare the sensor information with crop characteristics, weed characteristics, pest characteristics, or the like (e.g., images, color, shapes, density, or the like) to identify targets.

The target indexing module 404 determines the location of the identified targets and associates the location with the target. The target location can be used for logging for later analysis, comparisons with nozzle locations, or the like. The target location can include a location within the filed, location relative to a fiducial/reference in the field, location relative to the vehicle, fiducial/relative of the vehicle, or the like.

The target location comparator 406 compares the target location of the identified target(s) with one more nozzle location (e.g., GPS, RTK), such as nozzle locations (including nozzle assembly locations) along the sprayer boom. As the difference between the locations decreases and satisfies an approach threshold (e.g., difference of 0.0 inches, 2 inches, 6 inches or the like), the target module 400 can provide an application initiation instruction to the corresponding nozzle controller(s). Conversely, as the target location and nozzle location diverge and the difference satisfies a departure the threshold (e.g., difference of 2 inches, 6 inches, or the like), the target module 400 can provide an application arrest instruction to the corresponding nozzle controller(s). In some examples, the respective nozzle(s) is activated for a specified duration or distance after initiation and then automatically arrested.

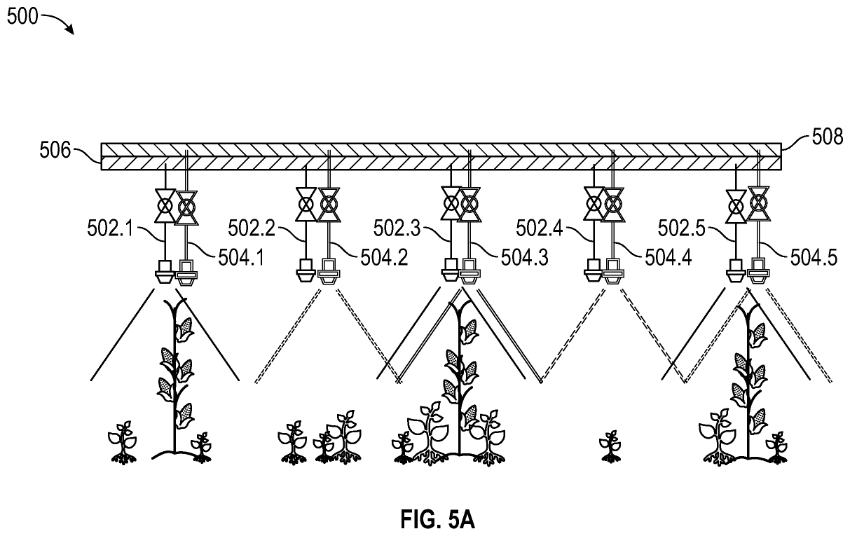

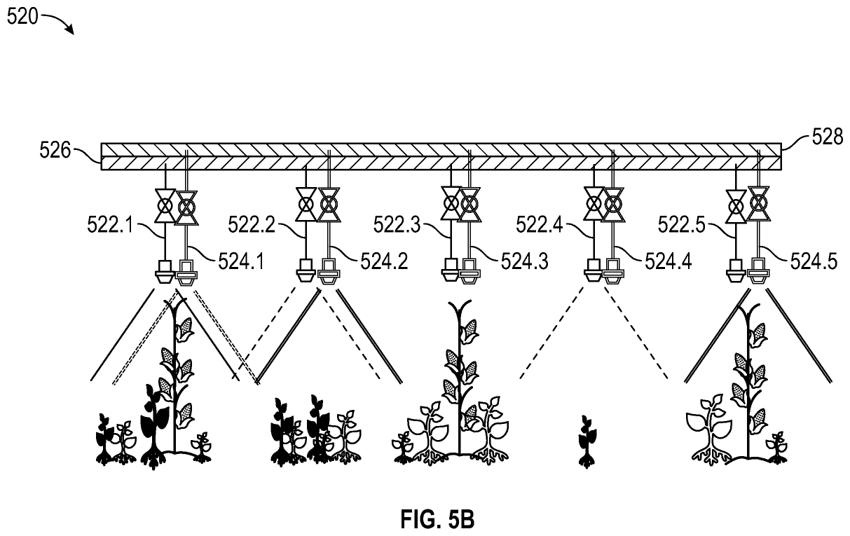

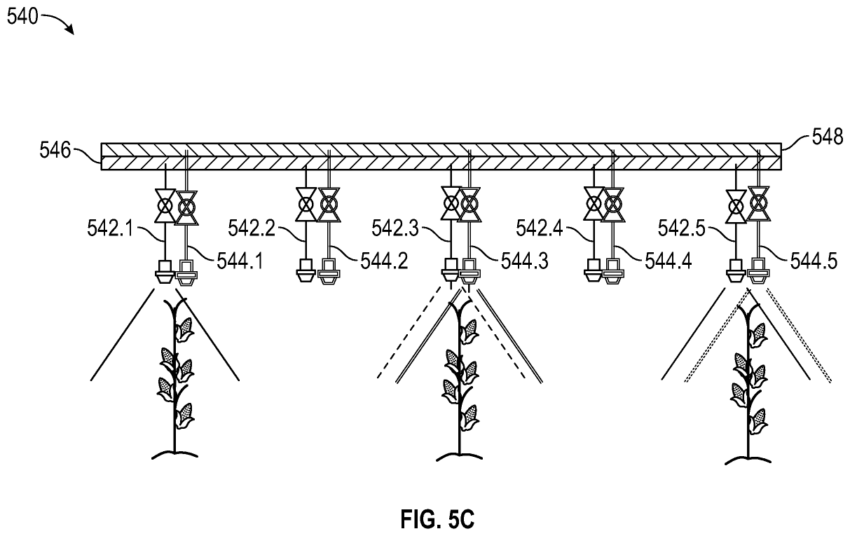

The agricultural product selector 408 controls application of the agricultural product based on the identified target. The agricultural product selector 408 may control section of agricultural product type, flow rate, flow quantity, droplet size, spray pattern, boom height, spray height, or the like. One or more agricultural products may be provided. Upon arrival at the target (e.g., determined with the target location comparator 406), an associated nozzle assembly is activated with it's a controller, and the selected agricultural product is applied based on the selection settings. In some examples, the system can include one or more modulating elements e.g., valves, modulating nozzles, or the like) to control distribution of the one or more agricultural products. The agricultural product selector 408 may set its selection settings (also referred to as application characteristics, e.g., agricultural product type, flow rate, flow quantity, droplet size, spray pattern, boom height, spray height, or the like) based on the identified target (e.g., type of weed, pest, crop, or the like). The selections are made based on one or more characteristics of the target, identification of the target, target location, or the like. The selections are provided to the corresponding controllers of the system, as described herein. The spraying techniques described herein can be used with different combinations of agricultural products. FIG. 5A is a schematic view of portions of an example configuration of the composite spraying system 500 with fertilizer and herbicide. The composite spraying system 500 includes a plurality of first nozzle assemblies 502.1-502.5, including a plurality of modulating elements and nozzles, as described herein. The composite spraying system 500 includes a plurality of second nozzle assemblies 504.1-504.5, including a plurality of modulating elements and nozzles, as described herein. The composite spraying system 500 also includes a composite boom tube with a first isolated passage 506 for storing a first agricultural product of fertilizer and a second isolated passage 508 for storing a second agricultural product of herbicide. Moreover, the composite spraying system 500 includes nozzle controllers, target modules, target sensors, etc., as described above. In this example, the first nozzle assemblies 502.1-502.5 are configured to apply fertilizer based on identified and indexed targets of crops to promote growth and yield. The second nozzle assemblies 504.1-504.5 are configured to apply herbicide based on identified and indexed targets of weeds to dispatch weeds. The identification and indexing of weeds may be based on the density level of detected weeds. Higher density may correspond to enhanced application of the herbicide. The composite spraying system 500 can also provide variations in flow rates and corresponding spray output of the first and second agricultural products based on identified targets proximate to the first and second nozzles.

FIG. 5B is a schematic view of portions of an example configuration of the composite spraying system 520 with different herbicides. The composite spraying system 520 includes a plurality of first nozzle assemblies 522.1-522.5, including a plurality of modulating elements and nozzles, as described herein. The composite spraying system 500 includes a plurality of second nozzle assemblies 524.1-524.5, including a plurality of modulating elements and nozzles, as described herein. The composite spraying system 520 also includes a composite boom tube with a first isolated passage 526 for storing a first agricultural product of a first type of herbicide and a second isolated passage 528 for storing a second agricultural product of a second type of herbicide. Moreover, the composite spraying system 500 includes nozzle controllers, target modules, target sensors, etc., as described above. In this example, the first nozzle assemblies 522.1-522.5 are configured to apply the first type of herbicide based on identified and indexed targets of a first type of weeds (e.g., bigger weeds) to dispatch the first type of weeds. The second nozzle assemblies 524.1-524.5 are configured to apply a second type of herbicide based on identified and indexed targets of a second type of weeds (e.g., smaller weeds) to dispatch the second type of weeds. The identification and indexing of weeds may be based on the density level of detected weeds. Higher density may correspond to enhanced application of the herbicide. The composite spraying system 500 can also provide variations in flow rates and corresponding spray output of the first and second agricultural products based on identified targets proximate to the first and second nozzles.

FIG. 5C is a schematic view of portions of an example configuration of the composite spraying system 540 with different fertilizers. The composite spraying system 540 includes a plurality of first nozzle assemblies 522.1-522.5, including a plurality of modulating elements and nozzles, as described herein. The composite spraying system 500 includes a plurality of second nozzle assemblies 504.1-504.5, including a plurality of modulating elements and nozzles, as described herein. The composite spraying system 500 also includes a composite boom tube with a first isolated passage 506 for storing a first agricultural product of a first type of fertilizer and a second isolated passage 508 for storing a second agricultural product of a second type of a fertilizer. Moreover, the composite spraying system 500 includes nozzle controllers, target modules, target sensors, etc., as described above. In this example, the first nozzle assemblies 502.1-502.5 are configured to apply the first type of fertilizer based on identified and indexed targets of a first type of crops (e.g., shorter crop) to promote enhanced growth and yield. The second nozzle assemblies 504.1-504.5 are configured to apply a second type of fertilizer based on identified and indexed targets of a second type of crops (e.g., taller crop) to promote growth and yield. The composite spraying system 500 can also provide variations in flow rates and corresponding spray output of the first and second agricultural products based on identified targets proximate to the first and second nozzles.

In some examples, the agricultural products can be the same product (e.g., same fertilizer, herbicide, pesticide, or the like), and the first nozzle assembly applies a first application (static or modulating flow rates) of the agricultural product while the second application nozzle assembly applies a second application of the agricultural product. The second application can be a targeted application applied to an identified and indexed target, supplemental application (e.g., 2x application), having varied flow rates, spray patterns, or the like. The second application can be static or dynamically vary relative to the first application.

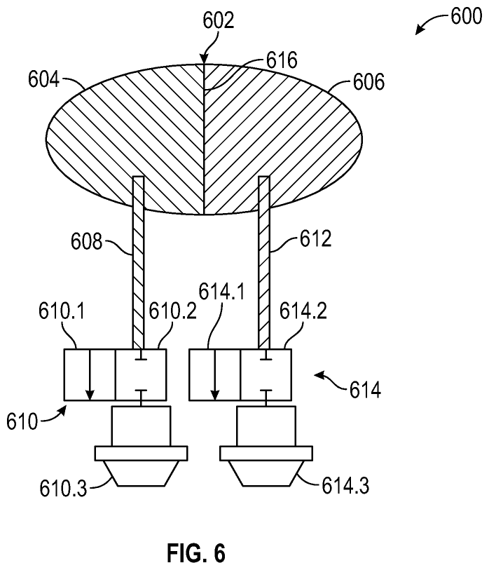

FIG. 6 is a schematic view of one example of a composite nozzle assembly 600. The composite nozzle assembly 600 includes an assembly of two or more nozzles configured to provide distinct applications of agricultural products (e.g., same or different). The composite nozzle assembly 600 includes a composite boom tube 602, which includes a first boom tube 604 and a second boom tube 606 separated by a boom tube septum 616. The boom tube septum 616 includes one or more septums to provide isolation fluids until mixed at nozzle assemblies. In some examples, the boom tube septum 616 includes a tube wall of nested tube within a tube.

The first boom tube 604 is configured to carry a first agricultural product, such as a carrier fluid (e.g., water, premixed agricultural product as a base, etc.). The first boom tube 604 is coupled to a first nozzle assembly 610 by a first assembly body 608. In some examples, the first assembly body 608 can be provided as component of the first nozzle assembly 610. The first nozzle assembly 610 includes a first modulating element 610.1, which can include one or more of control valves, orifice plates, air induction systems, modulating nozzles, or the like. The first nozzle assembly 610 includes a first flow modulating element 610.2, which can include one or more of control valves, orifice plates, air induction systems, modulating nozzles, or the like. The first nozzle assembly 610 also includes a first spray tip 610.3, such as a modulating nozzle.

The second boom tube 606 is configured to carry a second agricultural product, such as a carrier fluid (e.g., water, premixed agricultural product as a base, etc.). The agricultural product in the first boom tube 604 and second boom tube 606 includes, but is not limited to, the same agricultural product, carrier fluid such as water and agricultural product, combinations of different first and second agricultural products such as herbicide and pesticide, fertilizer and herbicide, first and second herbicides, first and second fertilizers or the like. The second boom tube 606 is coupled to a first nozzle assembly 614 by a second assembly body 612. In some examples, the second assembly body 612 can be provided as component of the second nozzle assembly 614. The second nozzle assembly 614 includes a second modulating element 614.1, which can include one or more of control valves, orifice plates, air induction systems, modulating nozzles, or the like. The second nozzle assembly 614 includes a first flow modulating element 614.2, which can include one or more of control valves, orifice plates, air induction systems, modulating nozzles, or the like. The second nozzle assembly 614 also includes a first spray tip 614.3, such as a modulating nozzle.

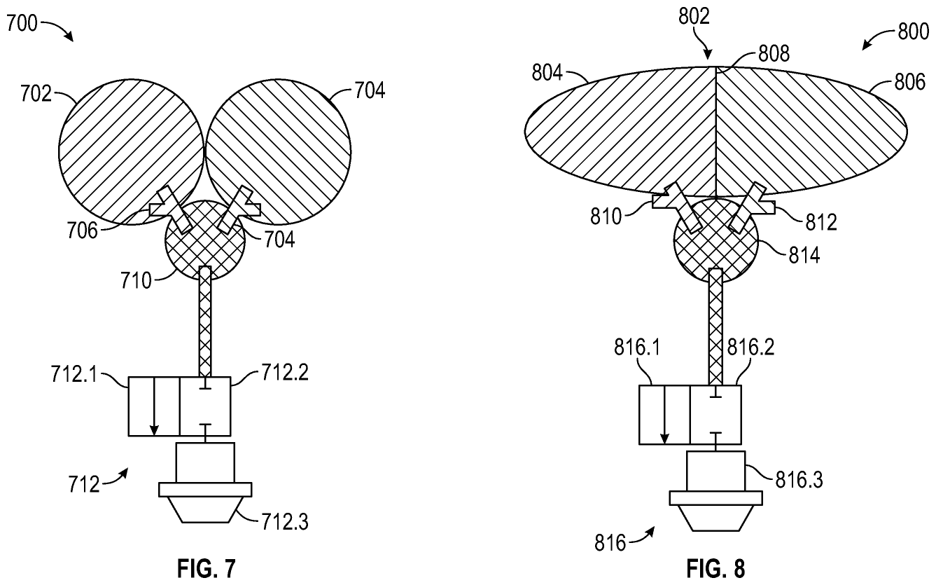

FIG. 7 is a schematic view of a modulating nozzle assembly 700 in communication first and second boom tubes. The modulating nozzle assembly 700 includes a first boom tube 702 and a second boom tube 704. The first boom tube 702 is configured to carry a first agricultural product, such as a carrier fluid (e.g., water, premixed agricultural product as a base, etc.). The second boom tube 704 is configured to carry a second agricultural product, such as a carrier fluid (e.g., water, premixed agricultural product as a base, etc.). The second agricultural product can be used for mixture in a mixing chamber 710 and then application.

Modulating inflow elements 706, 708 can include one or more control elements, such as valves, provided between the boom tubes 702, 704 and the mixing chamber 710 to independently control the composition of the agricultural product applied through a nozzle assembly 712. The mixing chamber 710 can include flutes, valves, or the like configured to interrupt laminar flow and turbulent fluids to ensure mixing.

The nozzle assembly 712 includes a modulating element actuator 712.1, a modulating element 712.2, and a spray tip 712.3. The modulating element actuator 712.1 controls operation of the flow modulating element 712.2 (e.g., a solenoid, stepper motor, servo motor or the like) and is in communication with one or more of the base nozzle controller, supplemental nozzle controller or the like, as described above. In some example, the flow modulating element 712.1 and the actuator 712.2 are collectively controlled (e.g., with the base nozzle controller). In another example, flow modulating element 712.1 and the actuator 712.2 are independently controlled, for instance with the supplemental nozzle controller actuating each nozzle assembly independently.

The modulating element 712.2 includes one or more of an operable control valve (or valves), modulating nozzle (example shown herein) or the like configured to control flow to provide a mixed flow of the carrier fluid and additive fluid while providing a specified droplet size. Examples include pulse width modulation valves, ball valves, orifice plates or nozzle fittings of the modulating nozzle or the like.

For example, as the additive flow rate is increased to the carrier fluid to increase additive concentration pressure of the mixed fluid increases thereby changing the droplet size (e.g., smaller). With a modulating nozzle, the nozzle is controlled to maintain a specified droplet size while at the same time adjusting to the increased flow rate.

The spray tip 712.3 can be a modulating spray trip, also referred to as a modulating nozzle. The spray tip 712.3 is configured to control one or both of droplet size and flow rate. In some examples, the spray tip 712.3 is a static or rotatable tip assembly including a plurality of spray tips (e.g., having different droplet sizes, spray profiles or the like).

FIG. 8 is a schematic view of the modulating nozzle assembly 800 in communication first and second boom tubes of a composite boom tube. FIG. 8 is a schematic view of one example of a composite nozzle assembly 800. The composite nozzle assembly 800 includes a composite boom tube 802, which includes a first boom tube 804 and a second boom tube 806 separated by a boom tube septum 808. The boom tube septum 808 includes one or more septums to provide isolation fluids until mixed at nozzle assemblies. In some examples, the boom tube septum 816 includes a tube wall of nested tube within a tube.

The first boom tube 804 is configured to carry a first agricultural product, such as a carrier fluid (e.g., water, premixed agricultural product as a base, etc.). The second boom tube 806 is configured to carry a second agricultural product, such as a carrier fluid (e.g., water, premixed agricultural product as a base, etc.). The second agricultural product can be used for mixture in a mixing chamber 814 and then application.

Modulating inflow elements 810,812 can include one or more control elements, such as valves, provided between the boom tubes 804, 806 and the mixing chamber 814 to independently control the composition of the agricultural product applied through a nozzle assembly 816. The mixing chamber 814 can include flutes, valves, or the like configured to interrupt laminar flow and turbulent fluids to ensure mixing.

The nozzle assembly 816 includes a modulating element actuator 816.1, a modulating element 816.2, and a spray tip 816.3. The modulating element actuator 816.1 controls operation of the flow modulating element 816.2 (e.g., a solenoid, stepper motor, servo motor or the like) and is in communication with one or more of the base nozzle controller, supplemental nozzle controller or the like, as described above. In some example, the flow modulating element 816.1 and the actuator 816.2 are collectively controlled (e.g., with the base nozzle controller). In another example, flow modulating element 816.1 and the actuator 816.2 are independently controlled, for instance with the supplemental nozzle controller actuating each nozzle assembly independently.

The modulating element 816.2 includes one or more of an operable control valve (or valves), modulating nozzle (example shown herein) or the like configured to control flow to provide a mixed flow of the carrier fluid and additive fluid while providing a specified droplet size. Examples include pulse width modulation valves, ball valves, orifice plates or nozzle fittings of the modulating nozzle or the like.

For example, as the additive flow rate is increased to the carrier fluid to increase additive concentration pressure of the mixed fluid increases thereby changing the droplet size (e.g., smaller). With a modulating nozzle, the nozzle is controlled to maintain a specified droplet size while at the same time adjusting to the increased flow rate.

The spray tip 816.3 can be a modulating spray trip, also referred to as a modulating nozzle. The spray tip 816.3 is configured to control one or both of droplet size and flow rate. In some examples, the spray tip 8162.3 is a static or rotatable tip assembly including a plurality of spray tips (e.g., having different droplet sizes, spray profiles or the like).

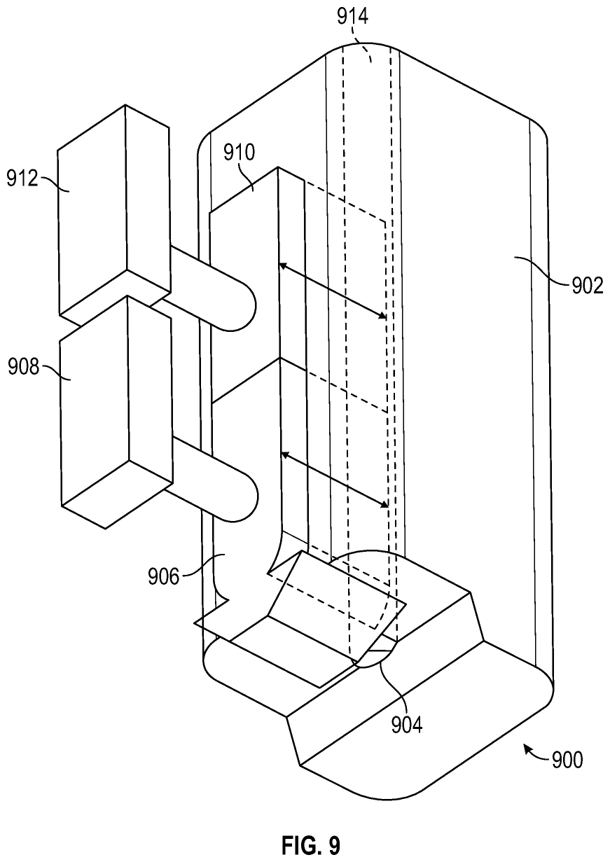

FIG. 9 is a perspective view of one example of a modulating nozzle assembly 900. The modulating nozzle assembly 900 is also referred to as a modulating spray tip and is configured to control one or both of droplet size and flow rate. The modulating assembly 900 includes a spray tip housing 902, a spray port 904, a nozzle 906, a nozzle fitting actuator 908, an orifice plate 910, an orifice plate actuator 912, and a passage 934.

The nozzle 906 is configured for positioning with the nozzle fitting actuator 908. Positioning the nozzle fitting 906 changes the profile of the spray port 904, such as the spray port size, shape, combinations of both or the like. For instance, with inward movement of the nozzle fitting 906, the profile of the spray port 904 is decreased, and the droplet size emanating from the spray port 904 is decreased (e.g., becomes finer). Conversely, movement of the nozzle fitting 906 toward the exterior increases the spray port 904 profile, and the droplet size emanated is increased (e.g., becomes coarser).

Optionally, flow is controlled with one or both of the nozzle 906 or orifice plate 910. With inward movement of either or both nozzle 906 and orifice plate 910, flow rate through spray port 904 is decreased (including shut off). Conversely, with outward movement of either or both nozzle 906 and orifice plate 910, additional flow is permitted through the spray port 904 and flow rate is increased.

The orifice plate 910 can include one or more orifice plates. Inward movement of the orifice plate 910 to contract the passage 914 increases the pressure drop across the orifice plate 910 and increases the droplet size emanating from the spray port 904. Conversely, movement of the orifice plate 910 to expand the passage 910 decreases the pressure drop across the orifice plate 910, and correspondingly maintains a higher pressure to the spray port 904 and decreases the droplet size emanating from the spray port 904. Additionally, inward and outward movement permit flow rate control (e.g., decrease and increase of flow rate).

The orifice plate actuator 912 (e.g., a pre-orifice actuator) controls the movement of the orifice plate 910. In some examples, the orifice plate 910 is modulated (e.g., moved, maintained or the like) relative to the passage 914 to control droplet size.

The passage 914 is in communication with the one or more of the boom tubes. In some embodiments, one or more supplemental modulating elements, such as valves, are interposed between the modulating spray tip (modulating nozzle) and the boom tubes. The supplemental modulating elements permit additional control of the applied agricultural product, for instance including flow rate control. Control of injection flow rates of agricultural products to other agricultural products, agricultural products to carrier fluids or the like.

### Various Notes and Aspects

Aspect 1 can include subject matter such as a supplementing spraying system for an agricultural sprayer comprising: a base nozzle array configured to spray an agricultural product, the base nozzle array includes: a plurality of base nozzles configured for installation along a sprayer boom; and a base nozzle controller in communication with the plurality of base nozzles, the base nozzle controller configured to control application of a base flow rate of the agricultural product from the plurality of base nozzles; a plurality of supplemental nozzle assemblies configured to spray a supplemental agricultural product, each supplemental nozzle assembly of the plurality of supplemental nozzles assemblies includes: a supplemental spray nozzle configured for installation between respective base nozzles of the plurality of base nozzles; and a modulating element in communication with the supplemental spray nozzle, the modulating element configured to controls a supplemental flow rate of the supplemental agricultural product from the respective supplemental spray nozzle; and a supplemental nozzle controller in communication with the plurality of supplemental nozzle assemblies, wherein the supplemental nozzle controller is configured to control the modulating elements of the plurality of supplemental nozzle assemblies.

Aspect 2 can include, or can optionally be combined with the subject matter of Aspect 1, to optionally include wherein the supplemental nozzle controller includes a plurality of supplemental nozzle controllers, wherein the modulating element of each supplemental nozzle assembly in communication with a respective supplemental nozzle controller of the plurality of supplemental nozzle controllers.

Aspect 3 can include, or can optionally be combined with the subject matter of one or any combination of Aspects 1 or 2 to optionally include wherein the respective supplemental nozzle controller is configured to independently control the associated modulating element.

Aspect 4 can include, or can optionally be combined with the subject matter of one or any combination of Aspects 1-3 to optionally include wherein the supplemental nozzle controller is configured to independently control the modulating elements of the plurality of supplemental nozzle assemblies.

Aspect 5 can include, or can optionally be combined with the subject matter of one or any combination of Aspects 1-4 to optionally include wherein the supplemental nozzle controller is configured to detect one or more target locations.

Aspect 6 can include, or can optionally be combined with the subject matter of Aspects 1-5 to optionally include wherein the supplemental nozzle controller includes a target comparator configured to compare a target location of the one or more target locations with at least one supplemental nozzle location of the plurality of supplemental spray nozzles.

Aspect 7 can include, or can optionally be combined with the subject matter of Aspects 1-6 to optionally include wherein the supplemental nozzle controller is configured to control one or more modulating elements of the supplemental nozzle assemblies based on the comparison of the target location with the at least one supplemental nozzle location.

Aspect 8 can include, or can optionally be combined with the subject matter of Aspects 1-7 to optionally include a target sensor in communication with the supplemental nozzle controller, the target sensor configured to monitor a preceding area relative to one or more of the supplemental nozzle assemblies; and wherein the supplemental nozzle controller is configured to identify a target and determine a target location of the target based on information from the target sensor.

Aspect 9 can include, or can optionally be combined with the subject matter of Aspects 1-8 to optionally include wherein the supplemental nozzle controller is configured to compare observations of the target sensor with one or more target identification characteristics to identify the target.

Aspect 10 can include, or can optionally be combined with the subject matter of Aspects 1-9 to optionally include wherein the supplemental nozzle controller includes a target comparator configured to compare a target location of the target with at least one supplemental nozzle location of the plurality of supplemental spray nozzles.

Aspect 11 can include, or can optionally be combined with the subject matter of Aspects 1-10 to optionally include wherein the one or more target identification characteristics include one or more crop characteristics, weed characteristics, or pest characteristics.

Aspect 12 can include, or can optionally be combined with the subject matter of Aspects 1-11 to optionally include wherein the base nozzle arrays are configured to apply the base flow rate of the agricultural product and the supplemental nozzle assemblies are configured to selectively apply the supplemental flow rate of the supplemental agricultural product to overlap the application of the base flow rate.

Aspect 13 can include, or can optionally be combined with the subject matter of Aspects 1-12 to optionally include a composite spraying system for an agricultural sprayer comprising: a first boom tube extending along a sprayer boom, the first boom tube configured to carry a first agricultural product; a second boom tube extending along the sprayer boom, the second boom tube configured to carry a second agricultural product; a plurality of composite nozzle assemblies positioned along the sprayer boom, each of the plurality of composite nozzle assemblies is in communication with the first and second boom tubes; at least one target sensor configured to observe targets preceding the plurality of composite nozzle assemblies; and at least one controller in communication with the at least one target sensor and the plurality of composite nozzle assemblies, the at least one controller configured to: identify a target observed with the at least one target sensor; index a target location of the identified target; select one or more of the first or second agricultural product for application based on the identified target; and compare the target location with a nozzle location of a composite nozzle assembly of the plurality of composite nozzle assemblies.

Aspect 14 can include, or can optionally be combined with the subject matter of Aspects 1-13 to optionally include wherein one or more composite nozzle assemblies of the plurality of composite nozzle assemblies include: a first nozzle assembly in communication with the first boom tube, the first nozzle assembly configured to control a first flow rate of the first agricultural product; a second nozzle assembly in communication with the second boom tube, the second nozzle assembly configured to control a second flow rate of the second agricultural product; and wherein the first and second nozzle assemblies are proximate each other on the sprayer boom.

Aspect 15 can include, or can optionally be combined with the subject matter of Aspects 1-14 to optionally include wherein one or more composite nozzle assemblies of the plurality of composite nozzle assemblies include a modulating nozzle assembly in communication with each of the first and second boom tubes, the modulating nozzle assembly having a modulating nozzle configured to control one or more of a combined flow rate of the first and second agricultural products or a droplet size of spray droplets.

Aspect 16 can include, or can optionally be combined with the subject matter of Aspects 1-15 to optionally include wherein a mixing chamber is interposed between the modulating nozzle assembly and the first and second boom tubes.

Aspect 17 can include, or can optionally be combined with the subject matter of Aspects 1-16 to optionally include wherein the at least one controller is further configured to: generate an instruction for initiating application of the selected agricultural product based on the comparison.

Aspect 18 can include, or can optionally be combined with the subject matter of Aspects 1-17 to optionally include wherein the at least one controller is further configured to: generate an instruction for arresting application of the selected agricultural product based on the comparison.

Aspect 19 can include, or can optionally be combined with the subject matter of Aspects 1-18 to optionally include a method for supplementing agricultural spraying comprising: applying a base flow rate of an agricultural product from a plurality of base nozzles; applying a supplemental flow rate of the agricultural product from one or more supplemental spray nozzles to a target, applying the supplemental flow rate includes: comparing a target location with a supplemental spray nozzle location; actuating a modulating element of the one or more supplemental spray nozzles based on the comparison; and spraying the agricultural product toward the target location with the one or more supplemental spray nozzles.

Aspect 20 can include, or can optionally be combined with the subject matter of Aspects 1-19 to optionally include wherein spraying the agricultural product toward the target locations includes overlapping a base spray pattern of at least one base nozzle of the plurality of base nozzles with a supplemental spray pattern with the one or more supplemental spray nozzles.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method aspects or examples described herein can be machine or computer-implemented at least in part. Some aspects or examples can include a computer-readable medium or machine-readable medium encoded with instructions operable to configure an electronic device to perform methods as described in the above aspects or examples. An implementation of such methods can include code, such as microcode, assembly language code, a higher-level language code, or the like. Such code can include computer readable instructions for performing various methods. The code may form portions of computer program products. Further, in an aspect or example, the code can be tangibly stored on one or more volatile, non-transitory, or non-volatile tangible computer-readable media, such as during execution or at other times. Aspects or examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A supplementing spraying system for an agricultural sprayer comprising:
a base nozzle array configured to spray an agricultural product, the base nozzle array includes:
a plurality of base nozzles configured for installation along a sprayer boom; and
a base nozzle controller in communication with the plurality of base nozzles, the base nozzle controller configured to control application of a base flow rate of the agricultural product from the plurality of base nozzles;
a plurality of supplemental nozzle assemblies configured to spray a supplemental agricultural product, each supplemental nozzle assembly of the plurality of supplemental nozzles assemblies includes:
a supplemental spray nozzle configured for installation between respective base nozzles of the plurality of base nozzles; and
a modulating element in communication with the supplemental spray nozzle, the modulating element configured to control a supplemental flow rate of the supplemental agricultural product from the respective supplemental spray nozzle; and
a supplemental nozzle controller in communication with the plurality of supplemental nozzle assemblies, wherein the supplemental nozzle controller is configured to control the modulating elements of the plurality of supplemental nozzle assemblies.

2. The supplementing spraying system of claim 1, wherein the supplemental nozzle controller includes a plurality of supplemental nozzle controllers, wherein the modulating element of each supplemental nozzle assembly in communication with a respective supplemental nozzle controller of the plurality of supplemental nozzle controllers.

3. The supplemental spraying system of claim 2, wherein the respective supplemental nozzle controller is configured to independently control the associated modulating element.

4. The supplemental spraying system of claim 1, wherein the supplemental nozzle controller is configured to independently control the modulating elements of the plurality of supplemental nozzle assemblies.

5. The supplemental spraying system of claim 1, wherein the supplemental nozzle controller is configured to detect one or more target locations.

6. The supplemental spraying system of claim 5, wherein the supplemental nozzle controller includes a target comparator configured to compare a target location of the one or more target locations with at least one supplemental nozzle location of the plurality of supplemental spray nozzles.

7. The supplemental spraying system of claim 6, wherein the supplemental nozzle controller is configured to control one or more modulating elements of the supplemental nozzle assemblies based on the comparison of the target location with the at least one supplemental nozzle location.

8. The supplemental spraying system of claim 1 comprising a target sensor in communication with the supplemental nozzle controller, the target sensor configured to monitor a preceding area relative to one or more of the supplemental nozzle assemblies; and
wherein the supplemental nozzle controller is configured to identify a target and determine a target location of the target based on information from the target sensor.

9. The supplemental spraying system of claim 8, wherein the supplemental nozzle controller is configured to compare observations of the target sensor with one or more target identification characteristics to identify the target.

10. The supplemental spraying system of claim 9, wherein the supplemental nozzle controller includes a target comparator configured to compare a target location of the target with at least one supplemental nozzle location of the plurality of supplemental spray nozzles.

11. The supplemental spraying system of claim 9, wherein the one or more target identification characteristics include one or more crop characteristics, weed characteristics, or pest characteristics.

12. The supplemental spraying system of claim 1, wherein the base nozzle arrays are configured to apply the base flow rate of the agricultural product and the supplemental nozzle assemblies are configured to selectively apply the supplemental flow rate of the supplemental agricultural product to overlap the application of the base flow rate.

13. A composite spraying system for an agricultural sprayer comprising:
a first boom tube extending along a sprayer boom, the first boom tube configured to carry a first agricultural product;
a second boom tube extending along the sprayer boom, the second boom tube configured to carry a second agricultural product;
a plurality of composite nozzle assemblies positioned along the sprayer boom, each of the plurality of composite nozzle assemblies is in communication with the first and second boom tubes;
at least one target sensor configured to observe targets preceding the plurality of composite nozzle assemblies; and
at least one controller in communication with the at least one target sensor and the plurality of composite nozzle assemblies, the at least one controller configured to:
identify a target observed with the at least one target sensor;
index a target location of the identified target;
select one or more of the first or second agricultural product for application based on the identified target; and
compare the target location with a nozzle location of a composite nozzle assembly of the plurality of composite nozzle assemblies.

14. The composite spraying system of claim 13, wherein one or more composite nozzle assemblies of the plurality of composite nozzle assemblies include:
a first nozzle assembly in communication with the first boom tube, the first nozzle assembly configured to control a first flow rate of the first agricultural product;
a second nozzle assembly in communication with the second boom tube, the second nozzle assembly configured to control a second flow rate of the second agricultural product; and
wherein the first and second nozzle assemblies are proximate each other on the sprayer boom.

15. The composite spraying system of claim 13, wherein one or more composite nozzle assemblies of the plurality of composite nozzle assemblies include a modulating nozzle assembly in communication with each of the first and second boom tubes, the modulating nozzle assembly having a modulating nozzle configured to control one or more of a combined flow rate of the first and second agricultural products or a droplet size of spray droplets.

16. The composite spraying system of claim 15, wherein a mixing chamber is interposed between the modulating nozzle assembly and the first and second boom tubes.

17. The composite spraying system of claim 13, wherein the at least one controller is further configured to:
generate an instruction for initiating application of the selected agricultural product based on the comparison.

18. The composite spraying system of claim 13,
wherein the at least one controller is further configured to:
generate an instruction for arresting application of the selected agricultural product based on the comparison.

19. A method for supplementing agricultural spraying comprising:
applying a base flow rate of an agricultural product from a plurality of base nozzles;
applying a supplemental flow rate of the agricultural product from one or more supplemental spray nozzles to a target, applying the supplemental flow rate includes:
comparing a target location with a supplemental spray nozzle location;
actuating a modulating element of the one or more supplemental spray nozzles based on the comparison; and
spraying the agricultural product toward the target location with the one or more supplemental spray nozzles.

20. The method of claim 19, wherein spraying the agricultural product toward the target locations includes overlapping a base spray pattern of at least one base nozzle of the plurality of base nozzles with a supplemental spray pattern with the one or more supplemental spray nozzles.
